(19) United States
(12) Patent Application Publication
(10) Pub. No.: US 2022/0089833 A1
(43) Pub. Date: Mar. 24, 2022

(54) RUBBER COMPOSITION AND VIBRATION DAMPING RUBBER INCLUDING RUBBER COMPOSITION VULCANIZED

(71) Applicant: Toyo Tire Corporation, Itami-shi (JP)

(72) Inventors: Hama Nagai, Itami-shi (JP); Norio Minouchi, Itami-shi (JP)

(73) Assignee: Toyo Tire Corporation, Itami-shi (JP)

(21) Appl. No.: 17/363,270

(22) Filed: Jun. 30, 2021

(30) Foreign Application Priority Data
Sep. 24, 2020 (JP) 2020-159409

(51) Int. Cl. C08K 3/04; C08L 7/00; C08C 19/20; B60K 5/12

(52) U.S. Cl. CPC C08K 3/04; B60K 5/12; C08C 19/20; C08L 7/00

(57) ABSTRACT

A rubber composition has a rubber component and recycled carbon black. The recycled carbon black has an ash content of 13% by mass or more. The rubber composition preferably further has a silane coupling agent. The rubber composition preferably has a content of the recycled carbon black of 5 to 60 parts by mass based on 100 parts by mass of a total amount of the rubber component.

### BACKGROUND OF THE INVENTION

### Field of the Invention

The present invention relates to a rubber composition and a vibration damping rubber including the rubber composition vulcanized. The present invention relates to a rubber composition that can be particularly suitably used as a vibration damping member such as an automobile engine mount, and to a vibration damping rubber including the rubber composition vulcanized.

### Description of the Related Art

Automobiles generally employ vibration damping rubbers to absorb vibrations of engines and vehicle bodies for improvement in riding comfort and prevention of noise. Vibration damping rubbers such as engine mounts used in automobile engine rooms and exhaust systems have been particularly required to have high heat resistance due to the recent increase in engine output.

Conventionally, vibration damping rubbers generally employ, as a rubber component, natural rubber or a blend of natural rubber and diene-based synthetic rubber. For rubber compositions containing such a rubber component, there is a known technique, for improvement of the heat resistance of the vulcanized rubber of the rubber composition, in which the amount of sulfur in the rubber composition is reduced and a large amount of vulcanization accelerator is blended for vulcanization (efficient vulcanization (EV) system).

The heat resistance of the vulcanized rubber is improved to a certain extent in the case that, as described above, the amount of sulfur in the rubber composition and the blending amount of the vulcanization accelerator are optimized, for improvement of the heat resistance of the vulcanized rubber, to increase the number of crosslinked forms with, for example, a monosulfide bond. However, in such a case, following problems occur. The number of sulfur molecules in the rubber composition is insufficient and therefore the cross linking is not sufficiently formed, so that the rubber hardness is reduced. As a result, the static spring constant (Ks) indicating the support performance of the vibration damping rubber is reduced, and at the same time, the dynamic spring constant (Kd) indicating the vibration damping performance against vibration and noise is increased, so that the value of the dynamic magnification (dynamic spring constant/static spring constant) as an index of the dynamic characteristic is increased, leading to reduction in vibration damping performance. Furthermore, a problem occurs that the strength and the rigidity of the rubber composition cannot be obtained to reduce the fatigue resistance, leading to deterioration of the durability of the vibration damping rubber.

As described above, in the technical field of vibration damping rubbers, development focusing on one characteristic often leads to deterioration of another characteristic, and development of a technique has been awaited for improvement in both reduction in the dynamic magnification and tear resistance in vibration damping rubbers.

Patent Document 1 below describes a rubber composition for a vibration damping rubber, including a rubber component containing diene-based rubber as a main component and recycled carbon black. Patent Document 2 below describes a rubber composition including carbon black having an ash content of 0.1 to 10% by mass, and a tire.

### PRIOR ART DOCUMENT

### Patent Document

[Patent Document 1] JP-A-2013-151584
[Patent Document 2] JP-A-2017-8223

### SUMMARY OF THE INVENTION

The present inventors intensively considered the above-described conventional techniques, and have found that the rubber compositions are inadequate to, for example, achieve both reduction in the dynamic magnification and tear resistance when used in a vibration damping rubber, and have room for further improvement.

The present invention has been made in view of the above-described situation, and an object of the present invention is to provide a rubber composition capable of achieving both reduction in the dynamic magnification and tear resistance particularly when used in a vibration damping rubber, and provide a vibration damping rubber obtained through vulcanizing the rubber composition as a raw material.

The above-described problem can be solved by the following configuration. That is, the present invention relates to a rubber composition including a rubber component and recycled carbon black, wherein the recycled carbon black has an ash content of 13% by mass or more.

The rubber composition preferably further includes a silane coupling agent.

The rubber composition preferably has a content of the recycled carbon black of 5 to 60 parts by mass based on 100 parts by mass of a total amount of the rubber component.

The present invention also relates to a vibration damping rubber including the rubber composition vulcanized.

The rubber composition according to the present invention includes a rubber component and recycled carbon black, and the recycled carbon black has an ash content of 13% by mass or more. This fact allows the vulcanized rubber of the rubber composition to achieve both reduction in the dynamic magnification and tear resistance. As a result, the vulcanized rubber can be particularly suitably used for vibration damping rubber applications. It is not clear why the vulcanized rubber of the rubber composition according to the present invention is allowed to achieve both reduction in the dynamic magnification and tear resistance. However, from the following phenomena (i) and (ii), it is considered that the dispersibility of the recycled carbon black is remarkably improved in the rubber composition, and furthermore, in the vulcanized rubber.
(i) The dispersibility of the recycled carbon black is remarkably improved in the rubber composition, and furthermore, in the vulcanized rubber because the recycled carbon black having an ash content of 13% by mass or more has a highly activated carbon black surface.
(ii) The ash itself containing silicon as a main component can also contribute to improving the dispersibility of the recycled carbon black in the rubber composition, and furthermore, in the vulcanized rubber.

If the rubber composition includes a silane coupling agent in addition to the recycled carbon black having an ash content of 13% by mass or more, it is possible to further reduce the dynamic magnification while maintaining the tear resistance in the vulcanized rubber. Although the reason for this fact is not clear, it is considered that the use of the recycled carbon black and the silane coupling agent in combination leads to further improvement of the dispersibility of the recycled carbon black having an activated surface.

### DETAILED DESCRIPTION OF THE PREFERRED EMBODIMENTS

The rubber composition according to the present invention includes a rubber component in which natural rubber is singly used, or a blend of natural rubber and diene-based synthetic rubber is used. In the case of blending natural rubber and diene-based synthetic rubber, examples of the diene-based synthetic rubber include polyisoprene rubber (IR), polybutadiene rubber (BR), styrene-butadiene rubber (SBR), butyl rubber (IIR), and acrylic nitrile-butadiene rubber (NBR). The polymerization method and the microstructure of the diene-based synthetic rubber are not limited, and one or more kinds of the diene-based synthetic rubber can be blended with natural rubber and used.

In blending natural rubber and diene-based synthetic rubber, the blending ratio is not particularly limited. In order to maintain the characteristic of natural rubber, the rubber component preferably contains natural rubber at a content of 50% by weight or more, and more preferably 90% by weight or more. Examples of the rubber that can be used as a rubber component include, in addition to natural rubber and diene-based synthetic rubber, synthetic rubbers including olefin-based rubber such as ethylene-propylene rubber (EPM), halogenated butyl rubber such as brominated butyl rubber (Br-IIR), polyurethane rubber, acrylic rubber, fluororubber, silicon rubber, chlorosulfonated polyethylene, and the like.

The recycled carbon black can be produced using a method known to those skilled in the art. However, if the recycled carbon black is produced through thermal decomposition at a high temperature, the degree of surface activation is increased, and the dispersibility of the recycled carbon black is remarkably improved in the rubber composition, and furthermore, in the vulcanized rubber. Therefore, in the present invention, it is preferable to use recycled carbon black obtained through thermal decomposition. In the present invention, from the viewpoint of increasing the degree of surface activation and improving the dispersibility of the recycled carbon black in the rubber composition, and furthermore, in the vulcanized rubber, the recycled carbon black having an ash content of 13% by mass or more is used. The upper limit of the ash content in the recycled carbon black is not particularly limited, and can be, for example, about 30% by mass. The ash content in the recycled carbon black can be measured in accordance with JIS K 6218-2. In order to further achieve both reduction in the dynamic magnification and tear resistance in the obtained vulcanized rubber, the blending amount of the recycled carbon black in the rubber composition is preferably 5 to 60 parts by mass, and more preferably 10 to 40 parts by mass based on 100 parts by mass of the total amount of the rubber component.

In order to improve the dispersibility of the recycled carbon black in the rubber composition, and furthermore, in the vulcanized rubber, the rubber composition according to the present invention preferably includes a silane coupling agent in addition to the recycled carbon black having an ash content of 13% by mass or more. The silane coupling agent may be any one usually used for rubber, and examples of the silane coupling agent include sulfide silanes such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as 3-mercaptopropyltrimethoxysilane, 3-mercaptopropyltriethoxy silane, 3-mercaptopropylmethyldimethoxysilane, 3-mercaptopropyldimethylmethoxy silane, and mercaptoethyltriethoxy silane; and protected mercaptosilanes such as 3-octanoylthio-1-propyltriethoxysilane and 3-propionyl thiopropyltrimethoxysilane. The silane coupling agents may be used singly or in combination of two or more kinds thereof. In order to further reduce the dynamic magnification while maintaining the tear resistance in the obtained vulcanized rubber, the blending amount of the silane coupling agent in the rubber composition is preferably 0.5 to 20 parts by mass, and more preferably 1 to 10 parts by mass based on 100 parts by mass of the total amount of the rubber component.

In the rubber composition according to the present invention, a compounding agent that is known to those skilled in the art and usually used in the rubber industry can be appropriately blended and used in addition to the rubber component, the recycled carbon black, and the silane coupling agent as long as an effect of the present invention is not impaired. Examples of the compounding agent include carbon black, sulfur, vulcanization accelerators, silica, zinc oxide, stearic acid, vulcanization accelerator aids, vulcanization retarders, organic peroxides, anti-aging agents, softeners such as waxes and oils, and processing aids.

As the carbon black other than the recycled carbon black, carbon black known to those skilled in the art can be used, and for example, SAF, ISAF, HAF, FEF, GPF, and the like are used. The ratio of (carbon black other than recycled carbon black)/(recycled carbon black) is preferably 0/100 to 80/20 in order to further achieve both reduction in the dynamic magnification and tear resistance in the vulcanized rubber through blending the recycled carbon black.

The sulfur may be ordinary sulfur for rubber, and sulfur such as powdered sulfur, precipitated sulfur, insoluble sulfur, and highly dispersible sulfur can be used. The content of the sulfur in the rubber composition for a vibration damping rubber according to the present invention is preferably 0.1 to 10 parts by mass based on 100 parts by mass of the rubber component.

As the vulcanization accelerator, vulcanization accelerators usually used for rubber vulcanization may be used singly or in appropriate combination. Examples of the vulcanization accelerators include sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators.

As the anti-aging agent, anti-aging agents usually used for rubber may be used singly or in appropriate combination. Examples of the anti-aging agents include aromatic amine-based anti-aging agents, amine-ketone-based anti-aging agents, monophenol-based anti-aging agents, bisphenol-based anti-aging agents, polyphenol-based anti-aging agents, dithiocarbamate-based anti-aging agents, and thiourea-based anti-aging agents.

The rubber composition according to the present invention is obtained through kneading the rubber component, the recycled carbon black, the silane coupling agent, and if necessary, sulfur, a vulcanization accelerator, zinc oxide, stearic acid, an anti-aging agent, a wax, and the like using an ordinary kneader used in the rubber industry, such as a Banbury mixer, a kneader, or a roll.

The method of blending the above-described components is not particularly limited, and a method may be used, for example, in which compounding components other than vulcanization components, such as sulfur and a vulcanization accelerator, are kneaded in advance to form a masterbatch, and the remaining components are added and further kneaded, or in which the components are added in an arbitrary order and kneaded, or in which all components are simultaneously added and kneaded.

The above-described components are kneaded, the resulting mixture is molded, and then the molded product is vulcanized to obtain a vibration damping rubber in which both reduction in the dynamic magnification and tear resistance are improved. Such a vibration damping rubber can be suitably used as vibration damping rubbers and seismic isolation rubbers such as vibration damping rubbers for automobiles such as engine mounts, torsional dampers, body mounts, cap mounts, member mounts, strut mounts, and muffler mounts, and in addition, vibration damping rubbers for railway vehicles, vibration damping rubbers for industrial machinery, seismic isolation rubbers for construction, and seismic isolation rubber supports. Such a vibration damping rubber is particularly useful as a structural member of vibration damping rubbers for automobiles in which reduction in the dynamic magnification and tear resistance are to be improved.

### EXAMPLES

Hereinafter, the present invention will be described in more detail with reference to Examples.

### (Preparation of Rubber Composition)

A rubber composition in each of Examples 1 to 15 and Comparative Examples 1 to 4 was blended with 100 parts by mass of a rubber component in accordance with the compounding formulation shown in Table 1, and the resulting mixture was kneaded using an ordinary Banbury mixer to prepare the rubber composition. The compounding agents shown in Tables 1 and 2 are as follows.

Polymer (natural rubber (NR)): RSS #3

Carbon black: product name “SEAST V” manufactured by TOKAI CARBON CO., LTD.

Recycled carbon black 1: product name “Pyro Carbon”, manufactured by Dongsung Ecore Co., Ltd. (ash content 11.9%)

Recycled carbon black 2: product name “rC6400” manufactured by Pyrolyx AG (ash content 14.0%)

Recycled carbon black 3: product name “cct-6400” manufactured by Pyrolyx AG (ash content 20%)

Silane coupling agent 1: product name “Si69” manufactured by Evonik Degussa GmbH

Silane coupling agent 2: product name “VP Si363” manufactured by Evonik Degussa GmbH

Silane coupling agent 3: product name “NXT” manufactured by Momentive Performance Materials Inc.

Zinc oxide: product name “Zinc White No. 3” manufactured by MITSUI MINING & SMELTING CO., LTD.

Fatty acid: product name “Industrial Stearic Acid” manufactured by Kao Corporation

Anti-aging agent 1: product name “NOCRAC 6C” manufactured by OUCHI SHINKO CHEMICAL INDUSTRIAL CO., LTD.

Anti-aging agent 2: product name “NOCRAC MBZ” manufactured by OUCHI SHINKO CHEMICAL INDUSTRIAL CO., LTD.

Sulfur: product name “5% Oil-Treated Sulfur” manufactured by Hosoi Chemical Industry Co., Ltd.

Accelerator 1: product name “NOCCELER DM-P (DM)” manufactured by OUCHI SHINKO CHEMICAL INDUSTRIAL CO., LTD.

Accelerator 2: product name “CZ” manufactured by OUCHI SHINKO CHEMICAL INDUSTRIAL CO., LTD.

Accelerator 3: product name “NOCCELER TT-P (TT)” manufactured by OUCHI SHINKO CHEMICAL INDUSTRIAL CO., LTD.

### Examples 1 to 15 and Comparative Examples 1 to 4

Each rubber composition was evaluated under the following conditions. In the production of vulcanized rubber, vulcanization was performed under the vulcanization conditions of heating at 170° C. for 13 minutes.

### [Tear Resistance]

A crescent test piece as a vulcanized rubber test piece was prepared under the above-described vulcanization conditions in accordance with JIS K6252-1. The force required to tear the test piece was measured in accordance with JIS K6252. The tear resistance in Examples 1 to 13 and Comparative Examples 2 to 3 was evaluated using an index determined as the proportion of the tear strength to the tear strength in Comparative Example 1 set to 100, and the tear resistance in Examples 14 to 15 was evaluated using an index determined as the proportion of the tear strength to the tear strength in Comparative Example 4 set to 100. The larger the index is, the better the tear resistance is. Tables 1 and 2 show the results.

### [Dynamic Magnification]

### (Static Spring Constant (Ks))

Each rubber composition was press-molded while vulcanized to prepare a vulcanized rubber sample having a columnar shape (diameter 50 mm, height 25 mm). The prepared test piece was compressed in the direction of the column axis by 7 mm twice, then a load deflection curve was obtained when the strain was restored, deflection loads were measured from the load deflection curve at deflections of 1.5 mm and 3.5 mm, and from the obtained values, a static spring constant (Ks) (N/mm) was calculated.

### (Dynamic Spring Constant (Kd))

The test piece used in the measurement of the static spring constant (Ks) was compressed in the direction of the column axis by 2.5 mm, the position after the 2.5 mm compression was set as the center, a constant-displacement harmonic compressive vibration with an amplitude of 0.05 mm was applied at a frequency of 100 Hz from below, the dynamic load was detected with a load cell set above, and a dynamic spring constant (Kd) (N/mm) was calculated in accordance with JIS-K 6394.

### (Dynamic Magnification: Kd/Ks)

The dynamic magnification was calculated from the following formula.

(Dynamic magnification)=(Dynamic spring constant (Kd))/(Static spring constant (Ks))

The dynamic magnification in Examples 1 to 13 and Comparative Examples 2 to 3 was evaluated using an index determined as the proportion of the dynamic magnification to the dynamic magnification in Comparative Example 1 set to 100, and the dynamic magnification in Examples 14 to 15 was evaluated using an index determined as the proportion of the dynamic magnification to the dynamic magnification in Comparative Example 4 set to 100. The smaller the index is, the lower the dynamic magnification of the vulcanized rubber is, and the better the vulcanized rubber is. Tables 1 and 2 show the results.

TABLE 1

| | Comparative | Comparative | | | | | | | |
|---|---|---|---|---|---|---|---|---|---|
| | Example 1 | Example 2 | Example 1 | Example 2 | Example 3 | Example 4 | Example 5 | Example 6 | Example 7 |
| Polymer | 100 | 100 | 100 | 100 | 100 | 100 | 100 | 100 | 100 |
| Carbon black | 35 | | 25 | 20 | 15 | | | | 25 |
| Recycled carbon | | 35 | | | | | | | |
| black 1 | | | | | | | | | |
| Recycled carbon | | | 10 | 15 | 20 | 35 | 35 | 35 | |
| black 2 | | | | | | | | | |
| Recycled carbon | | | | | | | | | 10 |
| black 3 | | | | | | | | | |
| Silane coupling | | | | | | | | | |
| agent 1 | | | | | | | | | |
| Silane coupling | | | | | | | | | |
| agent 2 | | | | | | | | | |
| Silane coupling | | | | | | | | | |
| agent 3 | | | | | | | | | |
| Zinc oxide | 5 | 5 | 5 | 5 | 5 | 5 | 5 | 5 | 5 |
| Fatty acid | 2 | 2 | 2 | 2 | 2 | 2 | 2 | 2 | 2 |
| Anti-aging agent 1 | 2 | 2 | 2 | 2 | 2 | 2 | 2 | 2 | 2 |
| Anti-aging agent 2 | 2 | 2 | 2 | 2 | 2 | 2 | 2 | 2 | 2 |
| Sulfur | 1 | 1 | 1 | 1 | 1 | 1 | 1 | 1 | 1 |
| Accelerator 1 | 2 | 2 | 2 | 2 | 2 | 2 | 1 | | 2 |
| Accelerator 2 | | | | | | | 1 | 2 | |
| Accelerator 3 | 0.5 | 0.5 | 0.5 | 0.5 | 0.5 | 0.5 | 0.5 | 0.5 | 0.5 |
| Tear resistance | 100 | 102 | 124 | 138 | 148 | 179 | 183 | 181 | 133 |
| Dynamic | 100 | 96 | 94 | 93 | 92 | 90 | 91 | 90 | 93 |
| magnification | | | | | | | | | |

| | | | | | | | Comparative |
|---|---|---|---|---|---|---|---|
| | Example 8 | Example 9 | Example 10 | Example 11 | Example 12 | Example 13 | Example 3 |
| Polymer | 100 | 100 | 100 | 100 | 100 | 100 | 100 |
| Carbon black | | 25 | 15 | | 20 | | |
| Recycled carbon | | | | | | | 35 |
| black 1 | | | | | | | |
| Recycled carbon | | 10 | 20 | 35 | 15 | 35 | |
| black 2 | | | | | | | |
| Recycled carbon | 35 | | | | | | |
| black 3 | | | | | | | |
| Silane coupling | | 1 | 2 | 3.5 | | | 3.5 |
| agent 1 | | | | | | | |
| Silane coupling | | | | | 1.5 | | |
| agent 2 | | | | | | | |
| Silane coupling | | | | | | 3.5 | |
| agent 3 | | | | | | | |
| Zinc oxide | 5 | 5 | 5 | 5 | 5 | 5 | 5 |
| Fatty acid | 2 | 2 | 2 | 2 | 2 | 2 | 2 |
| Anti-aging agent 1 | 2 | 2 | 2 | 2 | 2 | 2 | 2 |
| Anti-aging agent 2 | 2 | 2 | 2 | 2 | 2 | 2 | 2 |
| Sulfur | 1 | 1 | 1 | 1 | 1 | 1 | 1 |
| Accelerator 1 | 2 | 2 | 2 | 2 | 2 | 2 | 2 |
| Accelerator 2 | | | | | | | |
| Accelerator 3 | 0.5 | 0.5 | 0.5 | 0.5 | 0.5 | 0.5 | 0.5 |
| Tear resistance | 186 | 128 | 151 | 182 | 140 | 181 | 104 |
| Dynamic | 91 | 92 | 90 | 85 | 88 | 87 | 95 |
| magnification | | | | | | | |

TABLE 2

| | Comparative | | |
|---|---|---|---|
| | Example 4 | Example 14 | Example 15 |
| Polymer | 100 | 100 | 100 |
| Recycled carbon black 1 | 60 | | |
| Recycled carbon black 2 | | 60 | 60 |
| Silane coupling agent 1 | | | 4.8 |
| Zinc oxide | 5 | 5 | 5 |
| Fatty acid | 2 | 2 | 2 |
| Anti-aging agent 1 | 2 | 2 | 2 |
| Anti-aging agent 2 | 2 | 2 | 2 |
| Sulfur | 1 | 1 | 1 |
| Accelerator 1 | 2 | 2 | 2 |
| Accelerator 3 | 0.5 | 0.5 | 0.5 |
| Tear resistance | 100 | 123 | 127 |
| Dynamic magnification | 100 | 95 | 89 |

From the results shown in Tables 1 and 2, it is found that the vulcanized rubber of the rubber composition in Examples 1 to 15 can achieve both reduction in the dynamic magnification and tear resistance due to the improvement of the dispersibility of the recycled carbon black. In particular, it is found that in Examples 9 to 13 and 15, the vulcanized rubber of the rubber composition including a silane coupling agent in addition to the recycled carbon black having an ash content of 13% by mass or more can achieve further reduction in the dynamic magnification while maintaining the tear resistance of the vulcanized rubber because the recycled carbon black has further enhanced dispersibility due to the silane coupling agent used in combination. Meanwhile, in Comparative Example 2, the vulcanized rubber of the rubber composition including the recycled carbon black having an ash content of 11.9% by mass achieved little improvement in reduction in the dynamic magnification and tear resistance. Furthermore, in Comparative Example 3, the vulcanized rubber of the rubber composition including a silane coupling agent in addition to the recycled carbon black having an ash content of 11.9% by mass also achieved little improvement in reduction in the dynamic magnification and tear resistance.

What is claimed is:

1. A rubber composition comprising a rubber component and recycled carbon black, wherein
the recycled carbon black has an ash content of 13% by mass or more.

2. The rubber composition according to claim 1, further comprising a silane coupling agent.

3. The rubber composition according to claim 1, having a content of the recycled carbon black of 5 to 60 parts by mass based on 100 parts by mass of a total amount of the rubber component.

4. A vibration damping rubber comprising the rubber composition according to claim 1, the rubber composition vulcanized.
